(19) United States
(12) Patent Application Publication
(10) Pub. No.: US 2016/0171050 A1
(43) Pub. Date: Jun. 16, 2016

(54) Distributed Analytical Search Utilizing Semantic Analysis of Natural Language

(71) Applicant: Subrata Das, Belmont, MA (US)

(72) Inventor: Subrata Das, Belmont, MA (US)

(21) Appl. No.: 14/947,060

(22) Filed: Nov. 20, 2015

Related U.S. Application Data
(60) Provisional application No. 62/082,257, filed on Nov. 20, 2014.

(51) Int. Cl. G06F 17/30

(52) U.S. Cl. CPC G06F 17/30466; G06F 17/30463; G06F 17/30684

(57) ABSTRACT

A distributed Analytical search for data irrespective of location, content or format for querying multiple data sources by users who have no foreknowledge of the location or content of the data or metadata. Distributed Analytical Search (DAS) allows a user to pose natural language questions to multiple data stores of both structured and unstructured data of any size simultaneously without the user needing to know anything about the metadata of the source or sources and without any specialized knowledge of SQL or other computing technologies. Natural language queries are translated into machine recognizable queries and sub-queries based on database wrapper and then automatically executed on all or selected nodes in the domain, with the data owner(s) maintaining autonomy over their respective data stores.

### CROSS-REFERENCE TO RELATED APPLICATION

This application claims priority to U.S. Provisional Application No. 62/082,257 filed 20 Nov. 2014. The entire contents of the above-mentioned application is incorporated herein by reference.

### STATEMENT REGARDING FEDERALLY SPONSORED RESEARCH

Federal funds awarded by the U.S. Army under Contract No. W15P7T13CA752 contributed to making the invention. The U.S. Government has certain rights herein.

### FIELD OF THE INVENTION

This invention relates to distributed query planning, execution and optimization and more specifically to a distributed analytical search system for data irrespective of location, content or format for querying multiple data sources by users who have no foreknowledge of the location or content of the data or its metadata.

### BACKGROUND OF THE INVENTION

Currently, typical searches of proprietary data sources involve interacting with the data at varying levels of user expertise with native application querying tools such as canned reports or with query-by-example tools. Anything beyond a generic reporting typically requires the user either to be an expert in structured query language (SQL) or learn how to use a third party reporting tool. In such situations the user also needs access to and an understanding of the data source's data dictionary and database schema.

Further, for searches to yield beneficial results, the data being searched must be highly structured and in such a way that predicts how the data may be used in the future, such as by relying on accuracy and completeness of metadata. The term metadata in utilized herein in its broadest sense to include structural metadata, such as where particular data is stored, and descriptive metadata which identifies certain aspects of the data itself, such as how and when the data was created.

There is a need for improved, easy-to-use searching using existing XML (Extensible Markup Language) and other common features found in a variety of databases.

### BRIEF SUMMARY OF THE INVENTION

An object of the present invention is to provide a distributed analytical search system and technique for data irrespective of location, content or format for querying multiple data sources by users who have no foreknowledge of the location or content of the data or its metadata.

Another object is to provide a distributed analytical search for data irrespective of location, content or format that yields results that are more accurate than traditional keyword searches.

Yet another object is to provide such a search system that allows the user to enter natural language queries which are semantically analyzed relative to underlying data source meta data.

This invention features a system and method including accepting at least one query, from a user via at least one user interface, in natural language, and translating the natural language query into machine recognizable queries such as XML plans. The system and method optimize the machine recognizable queries, execute a search of at least one database; and generate at least one query result that is transmitted to the user.

A Distributed Analytical Search (DAS) system and method according to the present invention allows a user to pose natural language questions to multiple data stores of both structured and unstructured data of any size simultaneously without the user needing to know anything about the metadata of the source or sources and without any specialized knowledge of SQL or other computing technologies. Natural language queries are translated into an XML plan including machine recognizable queries and sub-queries with optimal execution order using available database wrappers and then automatically executed on all or selected nodes in the domain, with the data owner(s) maintaining autonomy over their respective data stores.

Other objects and advantages of the present invention will become obvious to the reader and it is intended that these objects and advantages are within the scope of the present invention. To the accomplishment of the above and related objects, certain embodiments of this invention are illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a schematic diagram illustrating the overall operation of one construction of a system and method of the present invention;

FIG. 2 is a schematic diagram showing one implementation environment for the system and method of FIG. 1;

FIG. 3 is a hypothetical screen shot showing representative natural language query, correct translation and top translations returned by the system and method of FIG. 1;

FIG. 4 is a schematic diagram illustrating the overall interaction of the system and method of FIG. 1 with multiple data sources and requisite select and join operations of individual result sets;

FIG. 5 is a hypothetical screen shot illustrating a sub-operation of the present invention showing representative database wrappers and sub-queries generated by the system and method of FIG. 1;

FIG. 6 is a hypothetical screen shot illustrating a sub-operation of the present invention showing representative XML query plan generated by the system and method of FIG. 1;

FIG. 7 is a schematic diagram illustrating a sub-operation of the present invention showing the query execution architecture of the system and method of FIG. 1;

FIGS. 8A-8B are schematic flowcharts illustrating translation of SQL statements to generate XML query blocks;

FIGS. 9A-9B are schematic flowcharts showing decomposition of a natural language query to weighted SQL queries; and

FIG. 10 illustrates subqueries of an SQL query generated by the present invention and execution of the subqueries by agents.

### DETAILED DESCRIPTION OF THE INVENTION

### A. Overview

A Distributed Analytical Search (DAS) system and method according to the present invention allows a user to pose natural language questions to multiple data stores of both structured and unstructured data of any size simultaneously without the user needing to know anything about the metadata of the source or sources and without any specialized knowledge of SQL or other computing technologies. Natural language queries are translated into machine recognizable queries and sub-queries based on database wrapper and then automatically executed on all or selected nodes in the domain, with the data owner(s) maintaining autonomy over their respective data stores.

This invention may be accomplished utilizing at least one processor executing a program performing the steps of accepting at least one query, from a user via at least one user interface, in natural language, and translating the natural language query into machine recognizable queries such as XML plans. The system and method optimize the machine recognizable queries, execute a search of at least one database; and generate at least one query result that is transmitted to the user.

Turning now descriptively to the drawings, in which similar reference characters denote similar elements throughout the several views, the Figures illustrate systems and techniques for distributed query planning, execution and optimization utilizing software developed using the Java programming language, Aglets, Stanford Parser, Apache Tomcat 8.0, the standard known as HTML5, consisting of Hypertext Markup Language, Cascading Style Sheet and Javascript.

### B. Architecture and its Components

The main functionality of distributed analytical search was developed with Java. Individual components can be run from a console, while the entire system was developed as a Java Web Application.

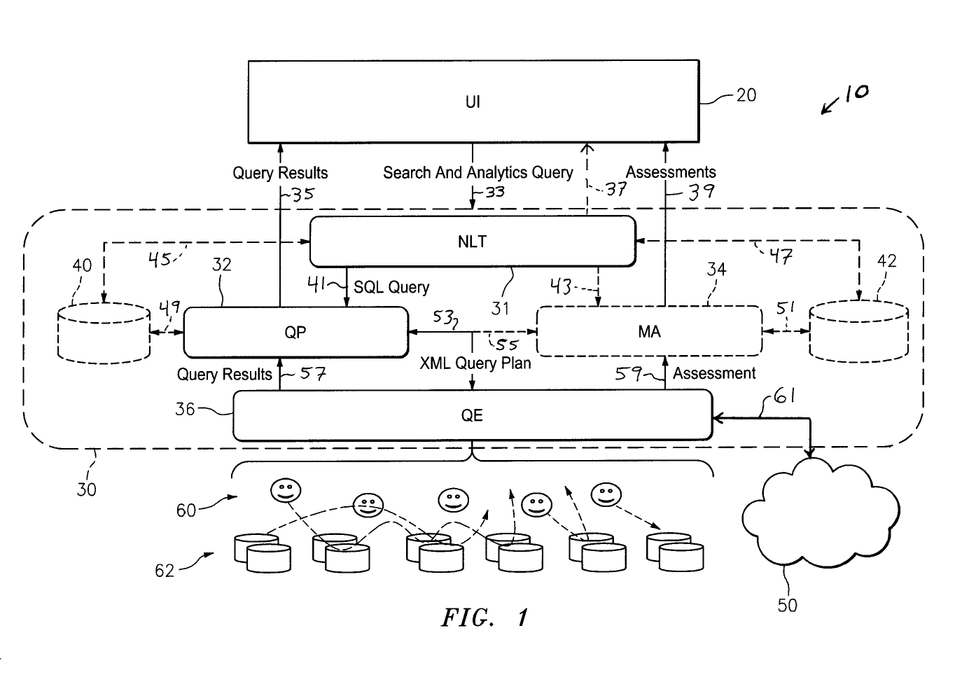

FIG. 1 illustrates the client-server architecture of DAS system 10. The architecture has a client Web-based Analyst Interface component 20 communicating with a Query Server component 30 over the internet or a secured connection. The interface 20 allows a user to specify search and analytics queries in a declarative manner via a high-level query language such as SQL, or in a natural-language-like syntax with constrained vocabulary. One of the major advantages of a web interface, as opposed to running the server component 30 on a client machine, is the increased security of having control over the server code and the agents 60 that it spawns.

The DAS Query Server component 30 conducts at least one of (i) direct access to one or more databases 50, as indicated by bi-directional arrow 61, and (ii) spawning of mobile agents 60 in a controlled manner, and the spawned agents 60 access distributed data sources 62 within a specified domain. As one example, the domain 50 accessed by server 30 is the Distributed Common Ground System Army (DCGS-A) Standard Cloud 50. A “cloud” can be considered just another data source, and hence more than one cloud can be considered, though only one is shown in the architecture. In fact, the server directs and controls all mobile-agent based generation, plans, and optimizations.

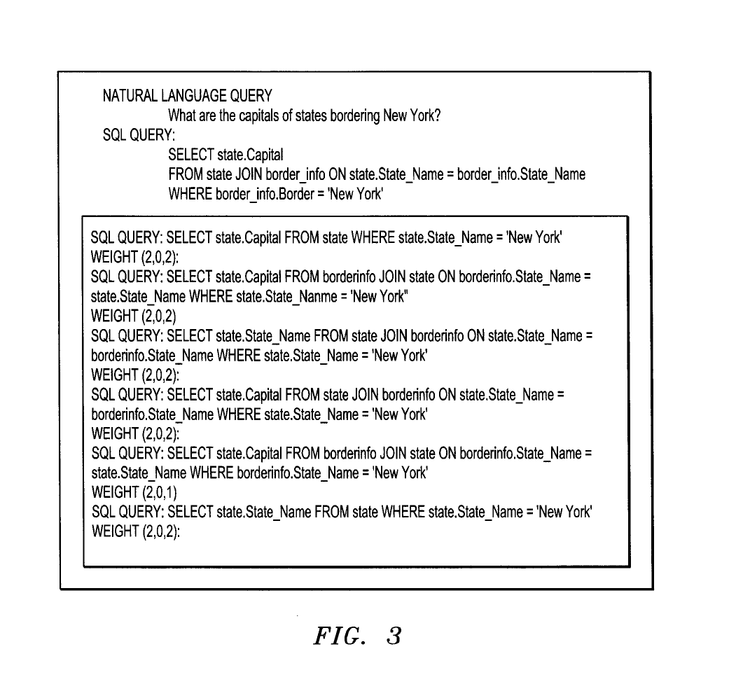

In another example, a mobile agent is spawned for each sub-query generated by the host to locate both postal code and state or country information, such as illustrated in FIG. 3 for capitals of states bordering New York; each agent is responsible for retrieving answers to its sub-query from the appropriate data source, including so-called cloud sources. There may be more than one data source involved in a sub-query, and when this is the case, the system intelligently constructs agent routes for traversing the required data sources. The use of multiple mobile agents enhances efficiency by retrieving data in parallel from any number of data sources.

In this construction, the Query Server component 30, FIG. 1, has three primary modules: a Distributed Query Planning and Optimization QP module 32, a Natural Language Translation NLT module 31 with Analytics Model Selection, and a Distributed Search and Query Execution QE module 36, which can include Distributed Belief Propagation. In certain constructions, the server component 30 further includes a Distributed Model-based Analytics MA module 34 and a model library 42, shown in phantom. Model-based Analytics module 34 can receive BN Model queries, dashed arrow 43, from NLT 31 and XML Query Plans, dashed arrow 55, from QP 32. Model library 42 optionally is accessed by NLT 31 and MA 34 as indicated by bi-directional dashed arrows 47 and 51, respectively. Also optional is a Metadata library 40 that is accessed by NLT 31 and QP 32 as indicated by bi-directional dashed arrows 45 and 49, respectively.

A set of sub-queries, arrow 53, is generated in the Query Planning and Optimization QP module 32 corresponding to a high-level search and analytics query, arrow 33, posed to server component 30 by a human analyst via Interface 20 and converted to at least one SQL Query 41 from NLT 31. In one construction, the module 32 makes use of a locally installed Domain and Site Model database 40 that contains data site descriptions and domain models. To maximize retrieval efficiency, the ordering of sub-queries is optimized by the QP module 32. An execution plan, arrow 53, for the sub-queries is then passed to the Query Execution module 36, which is responsible for generating and spawning the actual mobile agents 60 and/or direct access queries 61. If a part or the whole query is to be executed on the cloud, the module generates an appropriate program with embedded map and reduce functions following the MapReduce framework. The optimization strategy here is to best exploit in-built distributed execution and parallelism of the cloud.

Note that in a human-analyst-in-the-loop scenario, the analysts pose several queries to the DAS system 10 via interface 20 for enhanced situational awareness. For example, situation (and threat) assessment in a complex environment requires fusion of several sources and types of data. A query plan 53 from the Query Optimization module 32 is sent to QE 36, which in turn spawns mobile agents 60. Agents involved in the query communicate with each other and may perform “join” after select operations to fuse data where appropriate.

Natural language ambiguities along with parsing difficulties in general may prevent the optimum SQL translation of some natural language queries from appearing at the top of the list of possible translations. Hence, in one construction, feedback is obtained on one or more translated queries from the top of the list in a very structured fashion via a human-in-the-loop translation feedback as indicated by arrow 37 from NLT 31 to UT 20. Since SQL is a constrained language, an English-like representation of an initial, translated SQL query is produced to confirm the accuracy of the initial SQL query. For example, a translated query “SELECT Name, Capital FROM State WHERE State.Population >5000000” can be re-translated and represented in a natural language question as follows to ask the user to obtain feedback: “Do you want names and capitals of those states with population greater than five millions?” The user without any knowledge SQL can easily compare his original query with this re-translation and provide feedback accordingly. The feedback on accuracy or correctness can be beyond just yes and no but close for example pointing at certain parts of retranslation.

In another example, the architecture in FIG. 1 has been applied to a search and retrieval scenario involving distributed structured SALUTE repository and an analytics scenario to determine the level of threat from nuclear proliferation by a rogue nation. The search query involved retrieval of SALUTE data from various NAIs (Named Areas of Interest) within an operational area of an in-house scenario. A preliminary syntax was adopted for modeling data sources residing outside of the cloud, incorporating such constructs as repository, wrapper, interface, and extent.

Modeling a data source using a high-level language involves: 1) site modeling, that is, the description of the site where the data source resides, and 2) domain modeling, that is, the description of the object types and tables in the data source. The description of the sites and objects will be used by DAS to retrieve data from available data sources. We use an extended version of the ODMG-93 syntax (Cattell, R. G. G., “The Object Database Standard: ODMG-93”, 1994, Morgan Kaufmann) for data modeling which has also been used in Tomasic A., Raschid, L., and Valduriez, P., “Scaling heterogeneous databases and design of DISCO”, Proceedings of the International Conference of Distributed Computing Systems, pp. 449-457, 1996) for site and domain modeling.

In this example, a “select” type of query planning and “select-before-join” type of query optimization are chosen. After a planning and optimization step, the executive agent representing the query execution block sends an agent to execute the query at the site where terrain information is located. The results are then carried by two other agents in a temporary relation to the two sites of the SALUTE databases as determined by the following two extents definitions:

Extent salute0 of salute wrapper w0 repository r0.

Extent salute1 of salute wrapper w1 repository r1.

The ODMG standard consists of an object data model, an object definition language, an object query language, and a language binding. For site modeling, an instance of the Repository type is created, which defines the repository. For example:

R0:=Repository(host=“xyz. Army. Mil”, name=“non-DCGS”, address=“aaa. Bbb. . . . ”).

Creates an instance r0 of type Repository with the information necessary to access a data source in the repository. Other attributes such as the cost of accessing the data sources and typical turnaround time can also be added.

A wrapper is an object with an interface that identifies the schema and functionality of a source. When supplied with information on a repository and a query, it returns objects as answers to the query. Following are some of the wrapper object instances:

W0:=WrapperDCGS( );.

W1:=WrapperASAS( );.

W2:=WrapperRelational( );.

W3:=WrapperObject( );.

W0 will access the DoD's existing DCGS-A interface DSMS API and w1 will access DoD's existing ASAS (All Source Analysis System) interface to retrieve intelligence data specifically, whereas w2 and w3 are general wrappers to access respectively a relational and an object-oriented data sources.

The administrator defines the type of all objects in all data sources that constitute the domain model and will be transparent to the user. For example, the SALUTE type (a high-level intelligence data format; USMTF is another format) in the data sources w0 is defined in the object definition language of ODMG as follows:

```
Interface SALUTE {.
            Attribute Size size;.
            Attribute Activity activity;.
            Attribute Location location;.
            Attribute Unit unit;.
            Attribute Time time;.
            Attribute Equipment equipment;.
            Attribute Source from;.
            Attribute String remarks; }.
```

The attributes in the SALUTE interface are objects themselves and are explained in the following: size is the number of equipment observed (for example, 50); activity is the activity of the object (for example, moving west); location is the position of the object (for example, named are of interest NAI-3); unit represents the unit in which the object belongs (for example, divisional tank regiment); time is the time when the object observed (for example, 0845); equipment is the equipment associated with the object (for example, T-80 tank); from represents the SALUTE source (for example, UAV or Brigade Scout or JSTARS); and remarks is for optional remarks from the analyst who prepares the SALUTE report.

The administrator specifies the extent of the type SALUTE, which accesses the repository r0 utilizing the wrapper w0, as follows:

Extent salute0 of SALUTE wrapper w0 repository r0.

Wherein salute0 will be the relation name in the case of a relational repository r0. This specification adds the extent salute0 to the SALUTE interface, and states that access to objects in the data source are through the wrapper w0, and objects are located in the repository r0. Data access from repository r0 can be made through SQL-type queries as the following:

Select s. Unit.
From s in salute0.
Where s. Location = ‘NAI-68’.

The query does not require the source to be explicitly specified. In the case when there is another data source r1 that contains objects of type SALUTE, this requires adding another extent as follows:

Extent salute1 of SALUTE wrapper w1 repository r1.

To access objects of type SALUTE from both data sources, a query is posed as follows:

Select s. Unit.
From s in union {salute0, salute1}.
Where s. Location = ‘NAI-68’.

In a query as above, a user specifies each and every extent explicitly. In addition, it may be difficult for users to keep track of each time a new repository is added and a new extent is created. A special meta-data type MetaExtent to solve this problem is as follows:

```
Interface MetaExtent (extent metaextent) {.
            attribute String name;.
            attribute Extent e;.
            attribute Type interface;.
            attribute Wrapper wrapper;.
            attribute Repository repository;.
            attribute Map map;.
}.
```

And a new extent salute that refers all the extents can be defined as follows:

```
Interface SALUTE (extent salute) {.
            Attribute Size size;.
            Attribute String activity;.
            Attribute Location location;.
            Attribute Unit unit;.
            Attribute Time time;.
            Attribute String remarks; }.
```

Wherein the extent salute defined for the type SALUTE are as follows:

```
Define salute as flatten (.
            select me. E.
            from me in metaextent.
            where me. Interface = Metaextent ).
```

And an example query that dynamically accesses all the extents defined for the type SALUTE are as follows:

Select s. Unit.
from s in salute.
Where s. Location = ‘NAI-68’.

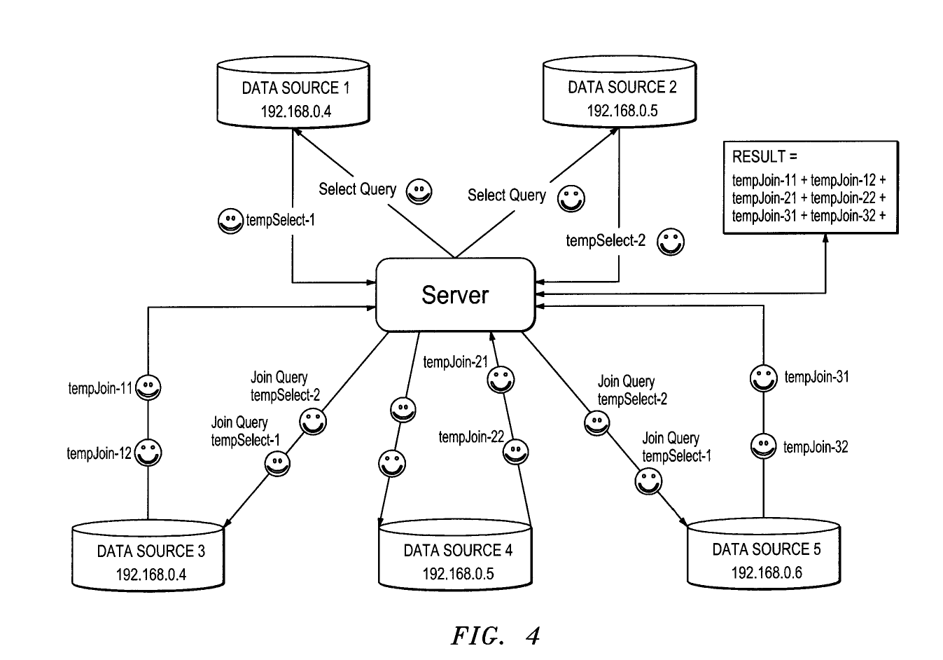

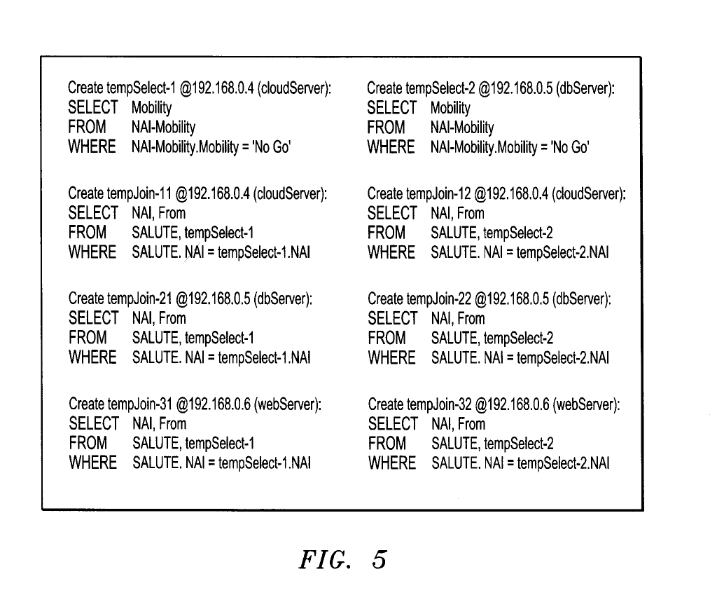

To answer a user search query, DAS will access stores of structured and unstructured data sources. These sources are distributed across servers as exemplified in FIG. 4 for Data Source 1 through Data Source 5. The server accesses information about available data, contents and locations modeled in two related tables with attributes such as database name, table name, IP address, server and wrapper. Columns available are further specified in a related table. Each row describes the location and other related information about a table in a database. Both tables will be accessed during query planning and decomposition.

In a preferred construction, Query Planning module 32, FIG. 1, includes a query translation module that automatically translates a natural language query to its equivalent SQL representation to be executed against structured data. The algorithm exploits the database metadata structure to generate a set of candidate SQL queries. It makes use of linguistic dependency relations generated by Stanford parser and a stemmer. The publicly available Stanford parser generates dependency relations from a given sentence representing a user query in the context of a given database. The algorithm, which is based on (Giordani, A. and Moschitti, A., “Automatic Generation and Reranking of SQL-Derived Answers to NL Questions”, Proc. of the Joint workshop on Intelligent Methods for Soft. System Eng., Montpellier, France) but with added heuristics for generating weights, also makes use of the underlying database scheme and its content.

Table 1 is an example query, heuristics and dependency relations:

Example Query: show Salute platforms from NAIs with mobility nogo.
Heurisics: If dependent is a modification of governor, pair together.

```
Dependency Relations: rel(gov, dep)
      root(ROOT-0, show-1)
      amod(platforms-3, Salute-2)
      dobj(show-1, platforms-3)
      case(NAIs-5, from-4)
      nmod(show-1, NAIs-5)
      case(nogo-8, with-6)
      amod(nogo-8, mobility-7)
      nmod(NAIs-5, nogo-8)
```

Table 1 above is an example of a natural language query relevant to our test database (not the scenario database) and its ideal translation which we intend to generate.

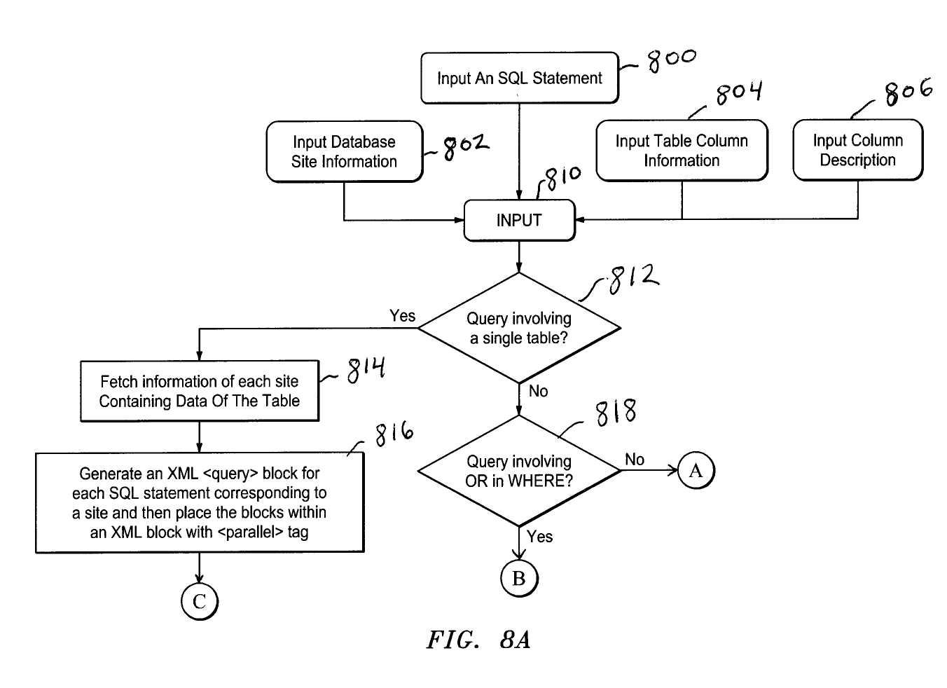

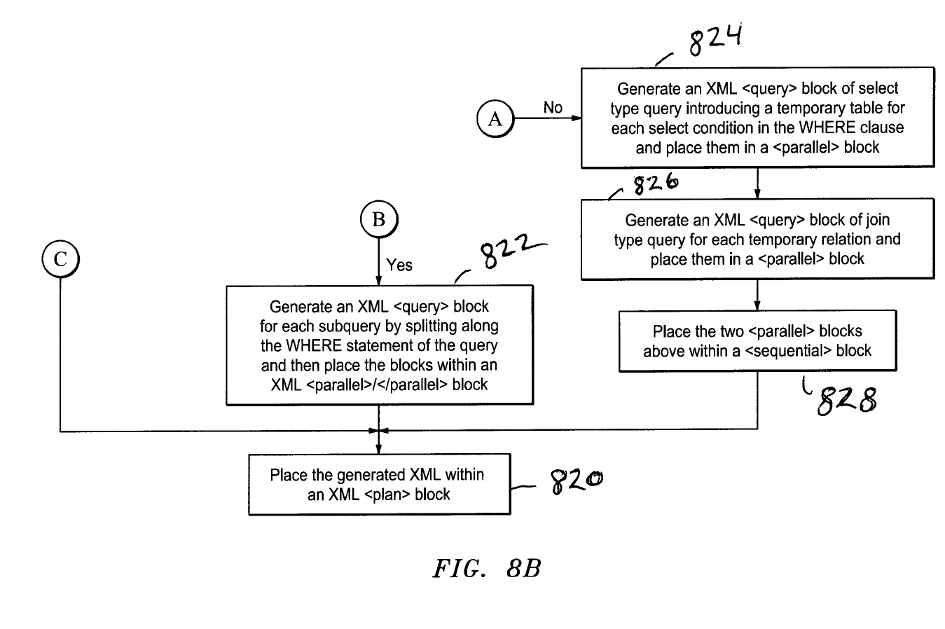

The translation routine that we have implemented generates a list of candidate translations sorted according to their weights, with higher weights indicating more accurate translations. The steps of the algorithm within one construction of query planning module 32, FIG. 1, are shown in FIGS. 8A-8B. The process begins in this construction with Input An SQL Statement, step 800, to Input 810. In one example, the SQL statement is “SELECT Capital FROM state”. In another example, the SQL statement is “SELECT Capital FROM state WHERE state.State_Name=‘Massachusetts’”. In a third example, the SQL statement is “SELECT state.Capital FROM state JOIN border_Info ON state.State_Name=border_Info.State_Name WHERE border_Info.Border=‘New York’”. In this construction, Input 810 also includes Input Database Site Information, step 802, such as details of Database, Table, Internet Protocol, Server, Port, User, Password, Size and/or Wrapper. Also included is Input Table Column Information, step 804, such as Server, Database, Table and Column, plus Input Column Description, step 806, such as Database, Term and/or Detail.

The process continues to decision step 812. If the Query involves a single table, then information of each site containing data of the table is fetched, step 814. The system then generates an XML <query> block for each SQL statement corresponding to a site and then places the blocks within an XML block with <parallel> tag, step 816, and continues to step 820, FIG. 8B, as described in more detail below.

If the Query involves more than one table, it is decided in decision step 818, FIG. 8A, whether the Query involves “OR in WHERE”. If Yes, then an XML <query> block is generated, step 822, FIG. 8B, for each subquery by splitting along the WHERE statement of the query and then placing blocks within an XML <parallel>/<parallel> block. If No is decided in step 818, FIG. 8A, then an XML <query> block is generated, step 824, FIG. 8B, of select type query introducing a temporary table for each select condition in the WHERE clause and placing them in a <parallel> block. The process then generates an XML <query> block of join type query, step 826, for each temporary relation and then places them in a <parallel> block. Two <parallel> blocks are then placed above within a <sequential> block, step 828. As a final step 820 after the actions of steps 816, 822 or 828 have been completed, the generated XML is placed within an XML <plan> block.

The output from this representative translation routine of FIGS. 8A-8B is shown in Table 1 above. Although one of the top candidates is our desirable translation, it would be more desirable to discard the remainder, leaving only the correct one. One approach is the use of machine learning algorithms on a large parallel corpus of natural language queries and their SQL translations; it would be desirable to then adopt an existing algorithm for machine translation between natural languages.

Returning to Query Planning and Optimization, query planning involves generating a set of sub-queries from a given user query based on the data source locations that have parts of the required information to answer the query. The optimization process then generates an efficient ordering of execution among these sub-queries.

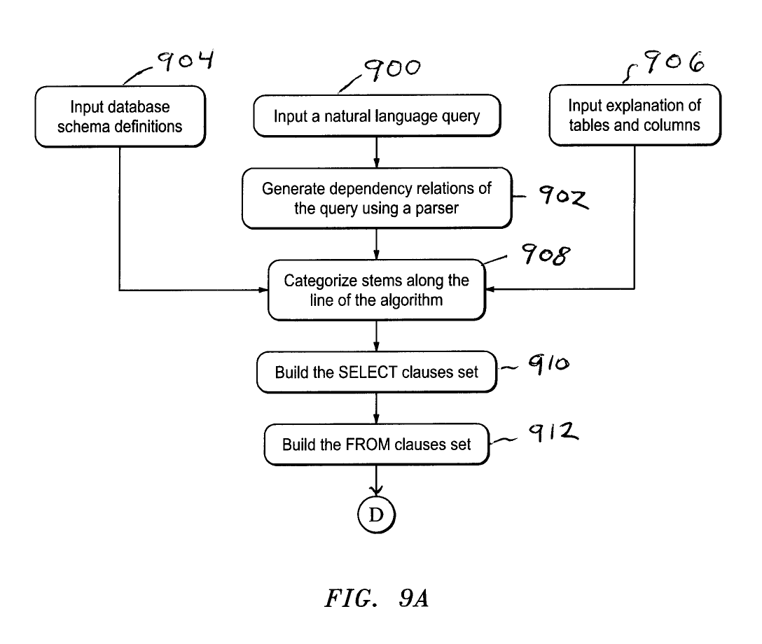

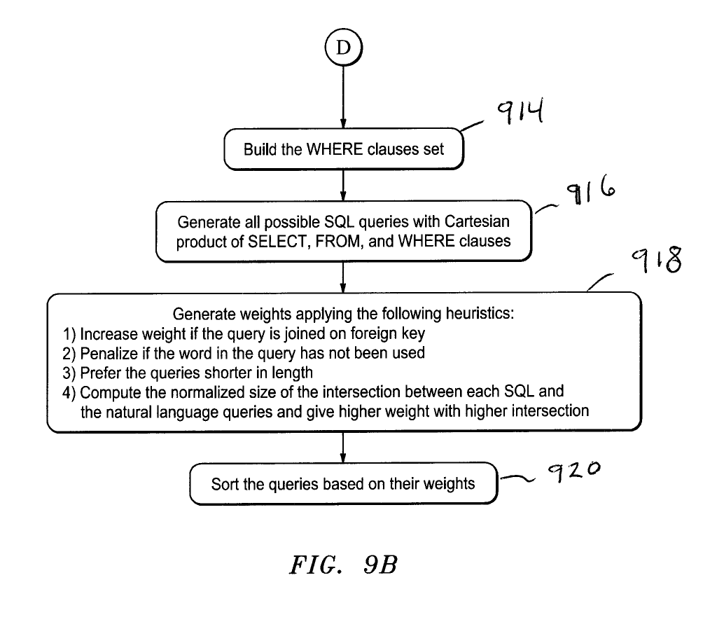

In one construction, query planning module 32, FIG. 1, includes a module with an algorithm derived from parallel database research that automatically decomposes a SQL query into a query plan composed of subqueries to be executed at distributed sites where data reside. An XML-based syntax represents such a plan 53 to be handed over to the query execution module 36 of the present architecture. Several specialized tags are used such as sequential and parallel. The subqueries within a parallel tag are executed in parallel at various sites whereas subqueries within a sequential tag are executed in sequence since a subquery depends on the result of one or more previous subqueries in the sequence. A primitive subquery is placed within the query tag to be executed at a site and hence contains information about the location, port, user, password, wrapper, etc. The overall steps of the algorithm is shown in FIGS. 9A-9B. Input step 900 includes a natural language query such as “What are the capitals of states bordering New York?” or “Show Salute platforms from NAIs with mobility nogo”. Dependency relations of the query are generated, step 902, using a parser such as the Stanford parcer. In this construction, input step 904 includes database schema definitions and input step 906 includes explanations of tables and columns. Utilizing the inputs from steps 902, 904 and 906, the system then categorizes stems along the line of the algorithm, step 908, such as described by Giordani and Moschitti in 2012, cited above. The system then builds the SELECT clauses set, step 910, and builds the FROM clauses set, step 912. The WHERE clauses set is then built, step 914, FIG. 9B, and the system generates all possible SQL queries with Cartesian product of SELECT, FROM and WHERE clauses, step 916. Weights are then generated, step 918, applying heuristics such as outlined in step 918. The queries are then sorted based on their weights, step 920.

The following example illustrates the concept of query planning and optimization with “select-before-join” type of queries as shown below. The query here (a translation of the original query posed in natural language via the web interface) finds the equipment/vehicles that are operating in a ‘no go’ named area of interest (NAI):

Select s. Equipment, t. Mobility.
From s in salute, t in nai-mobility.
Where s. Location = t. Location and t. Mobility = ‘no go’.

The optimization technique helps to identify the selection sub-query as follows to generate a temporary intermediate relation:

Select t. Mobility.
From t in nai-mobility.
Where t. Mobility = ‘no go’.

The executive agent sends an agent to execute the query at the site where terrain mobility information by NAIs is located. The results are then carried by two other agents in a temporary relation to the two sites of the SALUTE databases. The queries that are executed at the two SALUTE data sites are as follows:

Select s. Equipment, temp. Mobility select s. Equipment, temp. Mobility.
From s in salute0 from s in salute0.
Where s. Location = temp. Location where s. Location = temp. Location.

The results are brought back by the agents 60, FIG. 1, and merged as Query Results 57 from QE 36 and/or merged in QP 32, and presented as Query Results 35 to the user via the user interface 20. This kind of optimization avoids downloading the join relations to the user's local environment.

Our target is general query planning and optimization beyond the limited optimization described above. Consider a family of surveillance platforms (e.g., JSTARS, UAV, and AWACS) and assume that an extraordinary tactical event is reported (e.g., enemy tank T-80 is identified at the named area of interest NAI-68) in the SALUTE format prepared from the UAV mission during the interval (t1, t2). For an analysis through comparison, the analyst needs to access the intelligence data of that location for the interval (t1, t2) from other surveillance platforms as well as the information about terrain and weather during that period. The query involves access from various repositories containing intelligence and environmental data. A high-level user query to retrieve only the intelligence data in this regard will look like the following:

Select s. *.
From s in salute.
Where s. Location = ‘NAI-68’ and.
S. Time =< t1 and t2 =< s. Time.

Note that neither the repository nor the wrapper is mentioned in the query. If salute0 and salute1 are the only two tables respectively at repositories r0 and r1 containing SALUTE reports from the surveillance platforms, the above query will be translated as follows:

Select s. *.
From s in union {salute0, salute1}.
Where s. Location = ‘NAI-68’ and.
S. Time =< t1 and t2 =< s. Time.

Given the fact that repositories r0 and r1 are at different locations, the following two sub-queries will be generated corresponding to the above query:

| | |
|---|---|
| Select s. * | select s. *. |

| | |
|---|---|
| From s in salute0 | from s in salute1. |
| Where s. Location = ‘NAI-68’ and | where s. Location = ‘NAI-68’ and. |

| | |
|---|---|
| S. Time =< t1 and t2 =< s. Time | s. Time =< t1 and t2 =< s. Time. |

The above two sub-queries will be executed in parallel through wrappers w0 and w1 respectively. Not every sub-query will return a result, because the SALUTE report within a repository might not contain a reading of the surveillance platform s at that particular time interval (t1, t2).

To illustrate a typical “select before join” type traditional query optimization problem, suppose the analyst wants to retrieve data from every repository of all the SALUTE reports that have identified some terrorist group, along with the weapon types that are known to have been possessed by the group. Suppose the information about group names, styles, and weapons the group possesses are stored in a table with interface Enemy within a repository called central as follows:

```
Interface Enemy {.
      Attribute Group group;.
      Attribute Style style;.
      Attribute String weapon; }.
```

The attributes in the Enemy interface are explained in the following: group (for example, HAMAS, Al Qaeda), style (for example, openly aggressive, covert, neutral), and composition (for example, SAM, AK 47, night vision goggles, grenade, Truck). A high-level user query to answer the question posed above might look like the following:

select s. Unit, e. Weapon.
from s in salute, e in enemy.
where s. Unit <> ‘?’ and s. Unit = e. Group and e. Style = ‘Aggressive’.

Where enemy is the extent of Enemy appropriately defined. Note that the unit in a SALUTE report cannot always be identified positively, and ‘?’ denotes an unknown unit type. Suppose there are 100 records in enemy and 10,100 salute records of which 25 have unit names other than ‘?’. Using the same query decomposition technique described above, the following two sub-queries will be generated:

| | |
|---|---|
| Select e. Group | select s. Unit. |
| From e in enemy | from s in union {salute0, salute1}. |

The sub-queries will be executed in parallel to retrieve the necessary records to the client's local environment and then the constraint s. Unit < > ‘?’ and s. Unit=e. Group and e. Style=‘Aggressive’ in the join can be performed locally. There are three possible ways the above two sub-queries can be executed that will reduce the total number of 10,200 retrievals of records from two remote locations. The best probably is to execute the following query to retrieve 25 records from central repository:

Select s. Unit.
From s in union {salute0, salute1}.
Where s. Unit <> ‘?’.

Send the retrieved records as a temporary table, representing salute, to the local server of enemy, and execute the following query at the local server of enemy:

Select s. Unit, e. Group.
From s in salute, e in enemy.
Where s. Unit = e. Group.

This requires sending annotated (with data) queries to various data servers. In the above case, the server will create a temporary relation with the annotated data and then execute the query. DAS sends intelligent mobile search agents and annotated queries to a remote server.

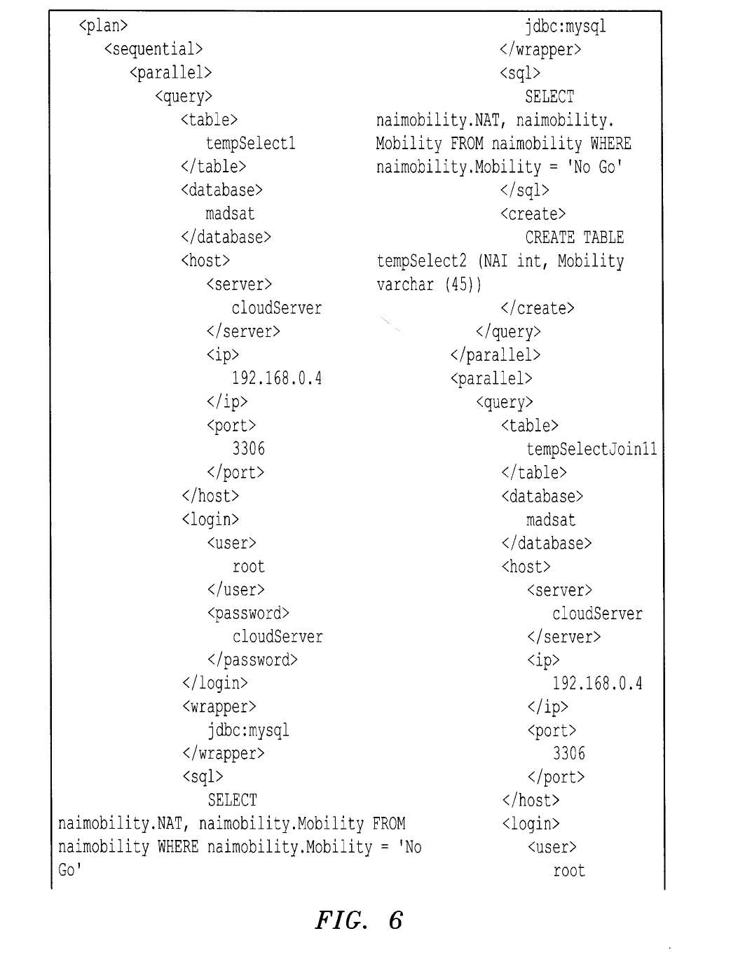

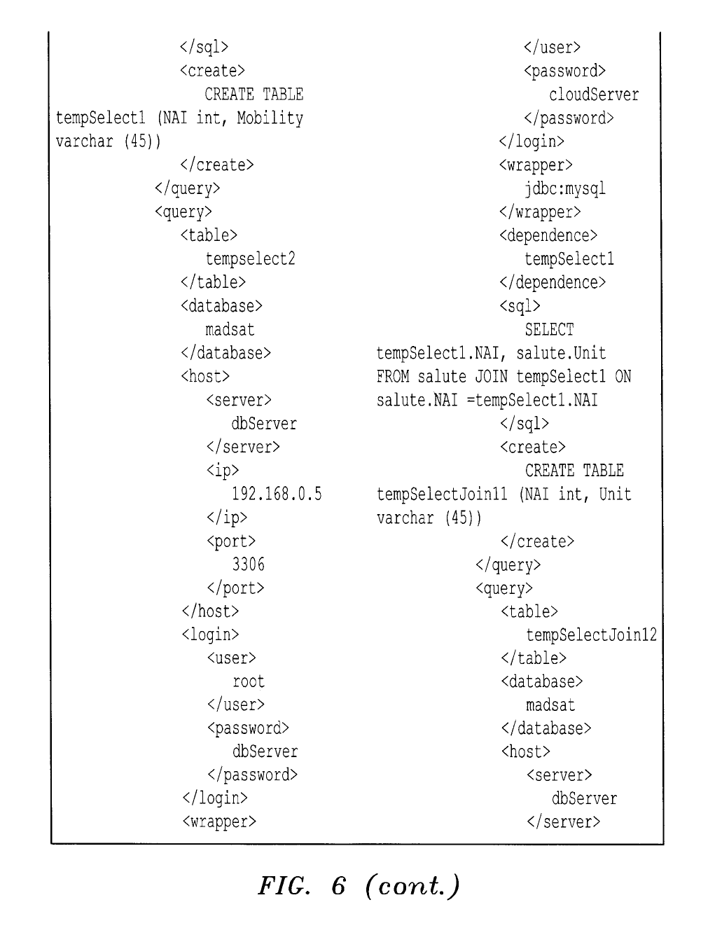

Once a natural language query is translated into its equivalent SQL query, we automatically decompose the output SQL query into a query plan composed of subqueries to be executed at distributed sites where data reside. Our implementation makes use of the two tables, Sites and Columns, as specified in the data source modeling section. In a way, the table Columns serves the purpose of the Interface construct above. The table Sites stores the physical location of tables. We have devised an XML-based syntax to represent such a plan to be handed over to the query execution module of the DAS architecture. An example SQL query is shown below. The corresponding XML query plan can be seen in FIG. 6.

SQL QUERY:
Select naimobility. NAI, salute. Unit.
From salute JOIN naimobility ON salute. NAI = naimobility. NAI.
Where naimobility. Mobility = ‘No Go’;

The representation makes use of various tags representing the order of execution of the subqueries. Also, each query block contains all the necessary information to execute the subquery within it, such as the host IP address where the query is to be executed, the wrapper, and the necessary login info to access data. This information comes from the two tables Sites and Columns in the locally installed Domain database.

The final step in carrying out a user's request for data is performed by the Query Execution module 36, FIG. 1. The Query Execution module controls all aspects of agent creation, migration, data retrieval, and collaboration. The QE module 36 receives a list of sub-queries 53 from the Query Planning and Optimization module 32 and generates a series of mobile agents 60 to carry out these sub-queries. For each agent, the module 36 creates an itinerary of the various sites to be visited and the data retrieval and processing tasks to be executed at each site. Each mobile agent is then spawned and the system waits for the return of each agent with its associated data. Upon return, the system performs any required data joining, processing, and formatting, including Assessments 59 and/or 39 (when Model-based Analytics module 34 is utilized) before displaying the results to the user via interface 20 in at least one perceptible format such as auditory answers and/or visual indicia.

Our mobile agent approach as shown in FIG. 1 creates multiple Plan Agents and Query Agents as part of the Query Execution module. These mobile agents were built on top of the Aglets 2.02 API running on the Java 1.8.20. Aglets is a Java mobile agent platform and library. An aglet is a Java agent that is able to autonomously and spontaneously move from one host to another. The Plan Agents and Query Agents inherit the properties of an Aglet.

Different types of execution mobilities exist (Jansen, W. and Karygiannis, T., “Mobile Agent Security”, NIST Special Publication 800-19, 1999) corresponding to the possible variations of relocating postal code and state information, including the values of instance variables, the program counter, execution stack, etc. For example, a simple agent written as a Java applet has mobility of code through the movement of class files from a web server to a web browser. However, no associated state information is conveyed. In contrast, Aglets, developed at IBM Japan, builds upon Java to allow the values of instance variables, but not the program counter or execution stack, to be conveyed along with the code as the agent relocates. A stronger form of mobility allows Java threads to be conveyed along with the agent's code during relocation. The DAS system design according to the present invention allows relocation of code information and state information.

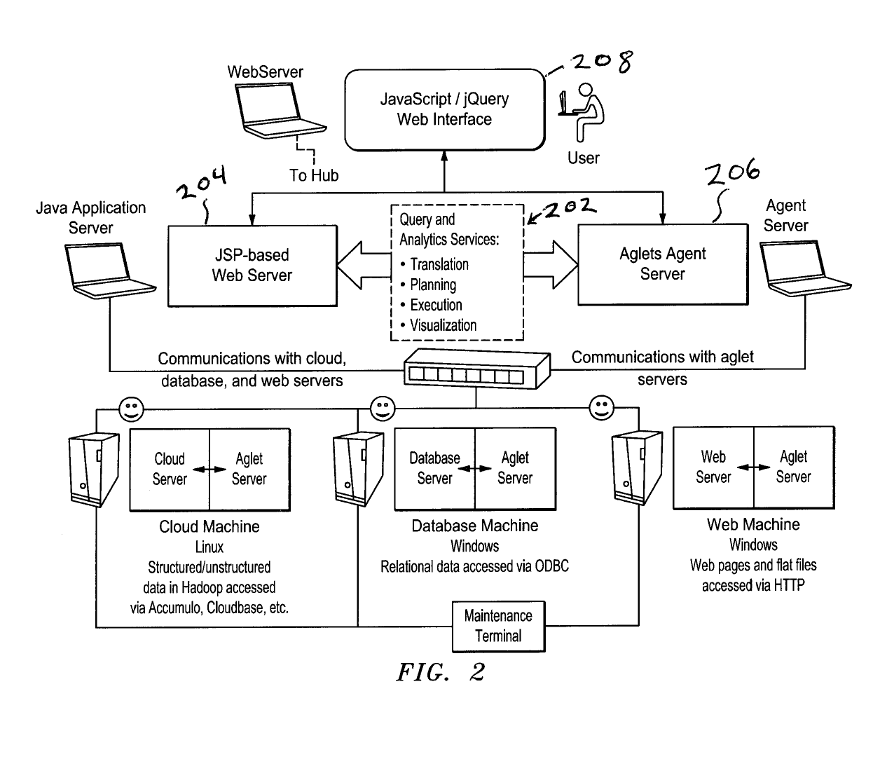

FIG. 2 illustrates one implementation environment for Query and Analytics Services 202 according to the present invention. Two main parts are interactions with JSP Server 204 and the Aglets Agent Servers 206. In one construction, a user submits a query using a web browser. The web interface 208 allows the user to specify search queries in a declarative manner via a natural-language-like syntax with constrained vocabulary in NLT 31, FIG. 1. This query will be processed by the JSP Server 204, FIG. 2, and passed on to the Planning and Optimization module 32, FIG. 1.

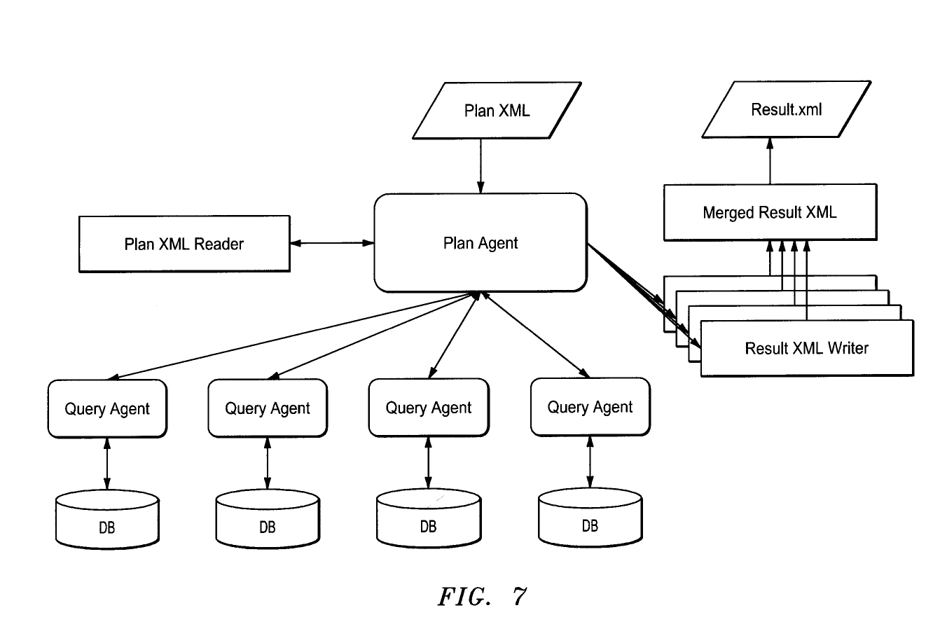

Planning and Optimization modules 32 are customized Java Objects that can process the transformation from a Natural Language Query and produce a plan of action in XML format. The user may then choose a desired transformation SQL and pass it back to the JSP Server 204 to create a plan of action in XML format. The XML file that was created will be processed by the Plan Agent as shown in FIG. 7.

The roles of the Agents that were customized from the Aglets API is illustrated in FIG. 7. The Plan XML file was read and processed. The Plan Agent creates Query Agents based on the number of queries obtained from the plan XML file. This XML file contains a plan of action created from a catalogue of available databases. Changing the availability of databases in the catalogue will reflect on the plan created in XML format.

The Query Agents are then dispatched to the remote computers containing the desired databases. The Query Agents perform all computations locally where the databases reside. Query Agents can be sent to remote machines and process SQL commands to different databases on those machines. The databases that we used for testing were MySQL and Derby. One of the advantages of using agents is that the database need not be open to outside connection. Since the agent had been sent to the remote machine, the agent has the ability to query the database locally. Query Agent also has the ability to create temporary database tables and carry out any standard SQL command.

Custom codes were designed with the assumption that the system has sufficient privileges to modify one or more databases involved in the query as well as permissions to read the corresponding tables across the network. These written codes have automated access to user defined queries obtained from the Planning and Optimization systems. The combined processed results from heterogeneous data from multiple sources are sent back to the Plan Agent, who will then save them into an XML format. The resulting XML files are visualized as single or multiple merged results.

Plan Agent, FIG. 7, was created by inheriting the properties of an Aglet. The Aglet class is provided by the Aglets API. Aglets need to be hosted by an agent host such as a Tahiti server. Plan Agent was instantiated within an Aglet Context that performs the role of sending messages to other Agents. The Aglet Context was created by the Tahiti Server which has a network daemon whose job is to listen to the network for other agents. Incoming agents are received and inserted into the context by the daemon. The Context provides all agents with a uniform initialization and execution environment. The Figures described above show the Plan Agent being created within the Tahiti Environment. Plan Agent has the ability to create Query Agents as needed and will be discussed in the next subsections.

The Plan Agent preferably can create, monitor, coordinate, retract, dispatch, and dispose Query Agents as needed. A Query Agent can be dispatched to a specific host (which itself hosts a database on the network) to visit and perform a specific function, computation, or query. Once an agent completes its tasks, it can send messages to other agents to perform other tasks such as creating temporary database tables or merging query results from different database tables. Agents also send messages to other agents to verify that they have reached their destinations and have completed their tasks. The Plan Agents have the ability to decide what path to take and what actions to perform as they gather data from the nodes that the Query Agent visits.

The Plan XML Reader, FIG. 7, reads XML files and stores the information in the form of Serialized objects. Serialized Objects are Java classes that can be converted into bytes and be sent over the wire. The instance of this class is saved and can be restored upon arrival to a destination. Serialization allows the persistence of an object from memory to a sequence of bits, and deserialization enables the reading of the data to recreate the object.

Plan Agent will create multiple Query Agents that can calculate and carry vital information while “hopping” to and from different machines. The number of Query Agents created depends upon the number of queries in the XML document. Multiple queries can be processed in parallel or sequentially in a distributed manner. Query Agents are deployed to different machines based on the plan XML file to process information from the remote databases. MySQL and Derby Test Databases were configured and used for testing.

The choice to use agents is to enable data to be left where it resides and only extract the required data on demand. The user writes a query in his own words and submits it using the web based user interface. A Natural Language program interprets and translates this request into SQL queries that are stored in XML format. The Plan Processor receives the XML file, containing a list of automatically generated sub-queries from the Planning and Optimization systems, and generates a Plan Agent. The Plan Agent creates and dispatches individual Query Agents to the database network. The Query Agent will process all computations and querying where the data reside, and send the processed results back to the Plan Agent. The Plan Agent will merge all the final results into a single answer. From the user's perspective, one query produces one combined answer and the complexities of the process have been hidden. The original data has not been moved nor modified. Only relevant data had been extracted and passed through the network.

In one example, several databases were loaded with gigabytes of data. A Plan Processor Java Object was designed and implemented to enable carrying huge data streams across the wires. A new scenario was developed and a series of tests were carried out to query new tables containing large amounts of data with a huge number of results that were carried across the wires. The testing was successful and gigabytes of data were obtained from a remote computer.

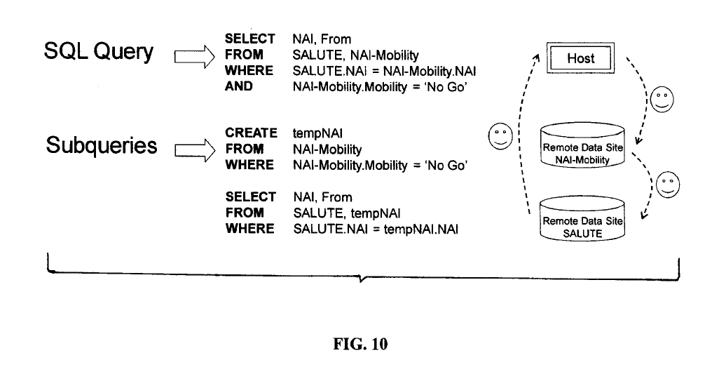

We have implemented a “select” type retrieval query and “select-before-join” type of query optimization. As shown in FIG. 10, an SQL translation of the original NLP query is broken down into two sub-queries. A representation of additional sub-queries can be seen in FIG. 5. In the example scenario the information about mobility and SALUTE reports is stored in two different locations. The host executive agent launches an agent containing an itinerary and query codes as follows. The agent first goes to the data site containing the mobility information and then executes the first sub query. The retrieved NAIs with “No Go” mobility are then put into a temporary table. The agent then transports itself, along with the temporary table, to the data site with the SALUTE records. The agent then executes the second sub query, which is a join type, involving the temporary table. The results of the sub query are then brought back by the agent to the host and displayed for the user. The hosting and control of agents at a site is done by the underlying agent platform Aglets, which we have described above.

The SALUTE and Mobility Tables 2 and 3 below show some sample rows as examples. These example tables are stored at remote sites. The distributed query execution as described above therefore avoids downloading large volumes of Mobility and SALUTE data records from these remote tables to the host site.

TABLE 2
SALUTE

| NAI | FROM | ACTIVITY | EQUIPMENT | TIME | SIZE |
|---|---|---|---|---|---|
| 47 | JSTARS | Milling | Vehicles | 14:20 | 40-60 |
| 65 | UAV | Emplaced | BMP | 18:12 | ? |
| 91 | LRS | Meeting | AK 47 | 10:30 | 100-200 |
| 20 | IMINT | Digging | Truck | 05:10 | 1 |
| . . . | . . . | . . . | . . . | . . . | . . . |

TABLE 3
NAI-Mobility

| NAI | Mobility |
|---|---|
| 47 | Slow Go |
| 23 | No Go |
| 49 | Go |
| 43 | Go |
| . . . | . . . |

The Plan Agent has the ability to create Query Agents that can travel autonomously through the network, providing an increased fault tolerance. The agents' ability to travel through the network and carry data along with them enables these agents to individually process queries in parallel and/or in sequence. The query execution module will not crash with a single point of failure and the query process may continue even if individual machines fail or become unavailable.

New computers or new database source may be added to the network. This feature offers better scalability of the module. We have created a data site table stored where users may add or delete existing data source. The Plan Agent has the ability to automatically increase the creation of Query Agents that can be dispatched to different computers. The ability to have the Query Agents travel through the system and execute their code using the host's resources allows for dynamic load sharing and automatic data processing.

In an example scenario for agent collaboration, three servers have been set up to emulate storing and serving big data from a variety of environments, including Hadoop-based cloud and a traditional relational database server. These servers are connected via a router proving fixed IP addresses to these servers, thus creating local area network. The servers are connected by a common maintenance terminal for configurations. Plan Agents and Query Agents work side by side with the Web Server and DAS Natural Language platforms and offer the user an integrated system with the ability to query different databases hosted on different machines. Network bandwidth usage is reduced because the use of mobile agent moves computation code to where the data resides.

The agents do not require a continuous connection between machines and the clients can dispatch an agent into the network when the network connection is healthy, and then it can go off-line. The network connection can be reestablished later when the result from the remote host is ready. This feature provides more reliable performance when the network connection is intermittent or unreliable.

Agents operate asynchronously and autonomously and the user doesn't need to monitor the agent as it roams the network. This saves time for the user, reduces communication costs, and decentralizes network structure.

The DAS Agents are constructed as lightweight processes, so that each process tests a single vulnerability. As new vulnerabilities are detected and tests for these vulnerabilities are developed, new agents can be added to the test suite. As the system configuration changes, some agents can be retracted or disposed of if they are no longer needed. Test suites can be fine-tuned for each individual node depending on its configuration. This increases the efficiency of the testing as tests are performed only when and where they are needed. A lightweight agent architecture makes the test suite configurable for heterogeneous environments.

In addition to agent based execution, distributed analytical search can be run with the option to directly query the databases specified on the plan XML document without using Agents. Efficiency of Agents had been investigated.

### C. Apache Tomcat 8.0 Web Server

Apache Tomcat was used to manage web server instances. Tomcat is a Java implementation of Servlet which allows a Java application to be served via HTTP.

This popular third party software was used to enable integration between the Java application and user interface. According to documentation found at http://tomcat. Apache. Org, Tomcat is an open source implementation of Java Servlets and Java Server.

### D. Stanford Parser

Stanford parser is one of a number of open source natural language processing libraries developed and maintained by the Stanford Natural Language Processing Group.

The parser has been used as a reference point in translating natural language strings. Our implementation extends and improves the performance of the “off-the-shelf” parser.

### E. Html5 User Interface

The suite of technologies generally referred to as HTML5 were used to develop a user interface (UI).

The UI is a so-called single page application (SPA) implemented with HTML5, a combination of HTML, JavaScript and Cascading Style Sheet. The UI was developed in this manner to both ensure cross platform compatibility and to give the user the look and feel of a desktop application.

### F. Aglets

Aglets is an open source mobile agent library developed by International Business Machines(IBM).

Aglets have been used to implement agent-based distributed query execution and data collection. Aglets traditionally have not been implemented to interact with HTTP. Our implementation extended and refactored such that the libraries function with modern implementations of Java beyond 1.6.Xx and also improved interaction with web based architecture.

### G. Operation of Preferred Embodiment

The application can be installed and deployed locally or remotely following the general architecture shown in FIG. 1. A typical interaction diagram between the application and data sources is illustrated in FIG. 2. In order to operate as intended the application database server needs to be seeded with domain information which includes node IP address(s), database names, database wrappers, tables to include and column names within those tables. IP addresses for target data sources are also included in this sites data table. It is also possible to collect metadata described above from remote nodes given the IP address(s).

The users interaction with the DAS application is entirely browser based using only HTTP protocol, with web server itself a gateway to an agent-hosting environment. The user need only enter the UI URL. Communication or integration between the UI and application has been implemented using asynchronous JavaScript and XML (AJAX). Communication may also be implemented continuous real-time communication via the Websocket protocol.

Upon accessing the DAS UI URL, the user will be presented with the single page application (SPA) in which various forms of queries can be selected including as a representative example free form natural language, facilitated natural language and structured query language. The user selects their desired query method and then chooses from among available domains. Available domains are populated at load time based on output from the application that the UI accesses via an AJAX call. It is also possible to manage available domains directly from the UI, i.e. add a domain or omit a domain.

Once a domain is selected, when queries are based on natural language the user either enters a query string or begins to enter a text string while the UI tries to find possible matches in a facilitated querying scenario. Via AJAX call to the application server. Once the user has entered the natural language query, translation into the requisite SQL is initiated. Translation into SQL relevant to the selected domain(s) is conducted via custom algorithm based on the Stanford Parser that ranks possible translations based on semantics. FIG. 3 demonstrates a representative natural language query and several of the possible SQL translations for a domain containing data about states.

The application returns all of the possible translations of the original natural-language-like query and the user in turn selects the desired SQL string to execute which initiates AJAX calls to the application server classes responsible for planning, optimizing and executing the query using direct cloud based queries to nodes on the network and agent based queries to nodes where this is appropriate.

The application prepares an XML based execution plan whereby a number of subqueries based on the original SQL translation selected are created and optimized prior to execution. A graphical representation of this process can be seen in FIG. 4 while an actual representation of an XML plan can be seen in FIG. 6. This process while fairly complex in nature happens in short order.

After the plan has been generated by the application it is possible to display a number of high level statistics regarding the pre-run state, such as how many queries will be executed, where queries will execute, approximation of completion time, etc.

Node availability may change during a specific run, and should a node or nodes become unavailable while a query is executing the application will return results based on available nodes, while the user is alerted as to where results are coming from and which nodes are not available. However should unavailable nodes become available during the course of execution, they will be included in the execution. It should be possible to provide the user with a list of available nodes prior to execution.

Results can be generated in any format ultimately desired but typically are generated in XML for display in the UI 20, FIG. 1, and partial results and/or assessments 39 are displayed to the user as soon as they are available.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims.

What is claimed is:

1. A method for searching structured and unstructured data in at least one database to generate query results, comprising:
accepting at least one query from a user in natural language;
translating the natural language query into machine recognizable queries;
optimizing the machine recognizable queries;
executing a search of the database; and
generating at least one query result.

2. The method of claim 1 further including spawning at least one query agent with embedded code and itinerary.

3. The method of claim 2 wherein the query agent is dispatched to a first site, selects specified data and creates a first table.

4. The method of claim 3 wherein the query agent carries the first table to a second site and performs a join operation with additional data.

5. The method of claim 1 wherein the machine recognizable queries include at least one XML query plan.

6. The method of claim 1 wherein translating the natural language query includes preparing at least one initial SQL query.

7. The method of claim 6 further including representing the initial SQL query in natural language to the user and requesting feedback from the user for the accuracy of the initial SQL query.

8. A system for searching structured and unstructured data in at least one database to generate query results, comprising:
at least one user interface capable of accepting at least one query from a user in natural language;
a translation module capable of translating the natural language query into machine recognizable queries;
a query planning and optimization module capable of optimizing the machine recognizable queries; and
a query execution module capable of executing a search of the database and generating at least one query result.

9. The system of claim 8 wherein the translation module is capable of preparing at least one initial SQL query and then representing the initial SQL query in natural language to the user and requesting feedback from the user for the accuracy of the initial SQL query.

10. A system for searching structured and unstructured data in at least one database to generate query results, including at least one user interface and at least one processor executing a program performing the steps of:
accepting at least one query, from a user via the user interface, in natural language;
translating the natural language query into machine recognizable queries;
optimizing the machine recognizable queries;
executing a search of the database;
generating at least one query result; and
transmitting the query result to the user.

11. The system of claim 10 further including spawning at least one query agent with embedded code and itinerary.

12. The system of claim 11 wherein the query agent is dispatched to a first site, selects specified data and creates a first table, and wherein the query agent carries the first table to a second site and performs a join operation with additional data.

13. The system of claim 12 wherein the machine recognizable queries include at least one XML query plan.

14. The system of claim 13 wherein the program is capable of preparing at least one initial SQL query and then representing the initial SQL query in natural language to the user and requesting feedback from the user for the accuracy of the initial SQL query.
